(19) United States
(12) Patent Application Publication
(10) Pub. No.: US 2023/0286124 A1
(43) Pub. Date: Sep. 14, 2023

(54) STRIKING TOOL AND METHOD OF OPERATING THE SAME

(71) Applicant: JS Products, Inc., Las Vegas, NV (US)

(72) Inventors: James Moore, Las Vegas, NV (US); Craig Steinfels, Powell, OH (US)

(21) Appl. No.: 18/119,217

(22) Filed: Mar. 8, 2023

Related U.S. Application Data
(60) Provisional application No. 63/318,605, filed on Mar. 10, 2022.

(51) Int. Cl. B25D 1/12; B25D 1/06; B67B 7/16

(52) U.S. Cl. CPC B25D 1/12; B25D 1/06; B67B 7/16

(57) ABSTRACT

A striking tool is provided. The striking tool includes a head, a handle coupled to or extending from the head, and an insert. The head defines a striking surface and has an opening therein. The insert is removably insertable into the opening of the head. The insert includes a cartridge having an interior space, a damping member located in the interior space, and a body located in the interior space. The body is movable with respect to the cartridge in order to allow the damping member to dampen vibration in the head.

### RELATED APPLICATION DATA

The present application claims priority to U.S. Provisional Application Serial No. 63/318,605, filed Mar. 10, 2022, which application is incorporated herein by reference in its entirety.

### FIELD OF THE INVENTION

The present invention relates to striking tools such as hammers, and methods of operating striking tools.

### BACKGROUND OF THE INVENTION

A variety of striking tools are known. One problem with manual striking tools is that they transmit force through the bodies thereof to the operator, such as to the operator’s hand(s). Some attempts have been made to reduce this transmission of force, but these solutions are often ineffective, or are complex and expensive.

An improved striking tool is desired.

### SUMMARY OF THE INVENTION

One aspect of the invention is directed to a striking tool. The striking tool includes a head, a handle coupled to or extending from the head, and an insert. The head defines a striking surface and has an opening therein. The insert is removably insertable into the opening of the head. The insert includes a cartridge having an interior space, a damping member located in the interior space, and a body located in the interior space. The body is movable with respect to the cartridge in order to allow the damping member to dampen vibration in the head.

The striking tool may comprise other features such as a bottle opener, side and/or rear fastener puller, magnetic fastener setter and the like.

The handle of the tool may comprise wood or metal.

In another aspect of the invention, a method of operating the striking tool is provided.

Further objects, features, and advantages of the present invention over the prior art will become apparent from the detailed description of the drawings which follows, when considered with the attached figures.

### DESCRIPTION OF THE DRAWINGS

FIG. 1 is a first perspective view of a striking tool in accordance with an embodiment of the invention;

FIG. 2 is another perspective view of the striking tool illustrated in FIG. 1;

FIG. 3 is a side view of the striking tool illustrated in FIG. 1;

FIG. 4 is a rear plan view of the striking tool illustrated in FIG. 1;

FIG. 5A is a exploded view of the striking tool illustrated in FIG. 1;

FIG. 5B is a cross-sectional view of the portion of the tool illustrated in FIG. 5A;

FIG. 5C is another example of the insert illustrated in FIG. 5B;

FIG. 6 is a cross-sectional view of the striking tool illustrated in FIG. 1, taken along line 6-6 therein;

FIG. 7 is a cross-sectional view of the striking tool illustrated in FIG. 6 taken along line;

FIG. 8 is a cross-sectional view of the striking tool illustrated in FIG. 6 taken along line 8-8 therein;

FIG. 9 is a first perspective view of a striking tool in accordance with another embodiment of the invention; and

FIG. 10 is another perspective view of the striking tool illustrated in FIG. 9.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

As employed herein, the term “coupled” shall mean connected together either directly or via one or more intermediate parts or components.

One embodiment of the invention is a striking tool. In one embodiment, the striking tool is configured as a hammer having a striking head and a handle. In one embodiment, the striking tool includes an anti-vibration feature in the form of an adjustable damping mass. The adjustable damping mass may be insertable into and removed from the head. The striking tool may include other features such as a magnetic nail starter, rear and/or side nail pullers, and a bottle opener.

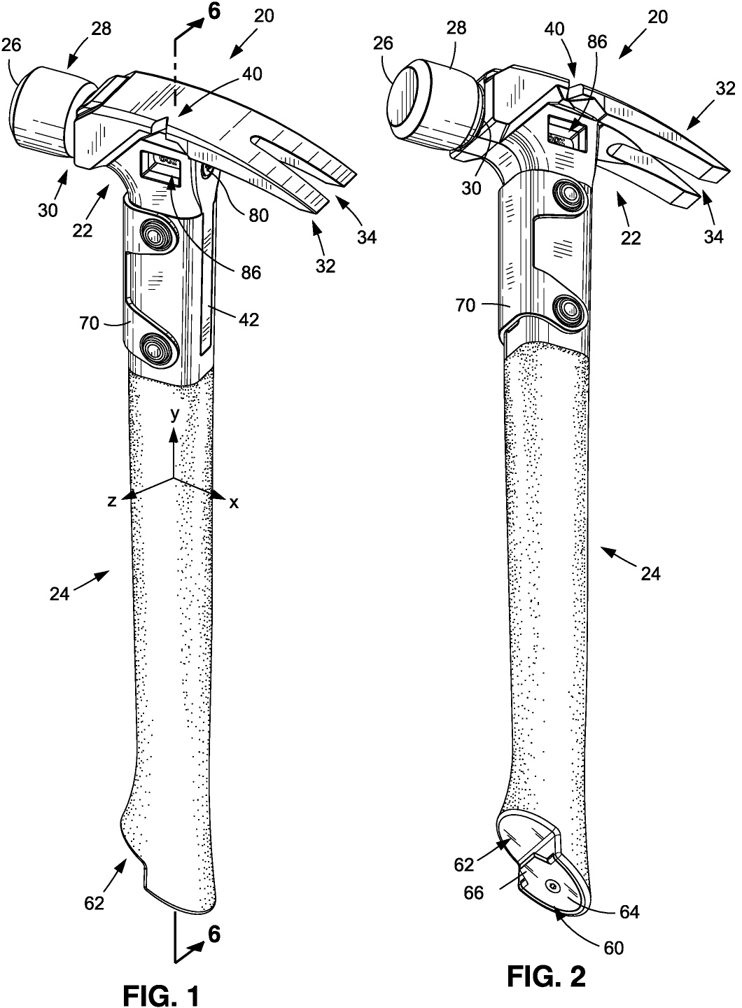

One embodiment of the invention is illustrated in FIG. 1. In general, a striking tool 20 has a head 22 which is connected to a handle 24. The striking tool 20 may be configured as a hammer that is structured to strike, for example, a nail, and drive the nail into a structure. The head 22 may generally have a front and a generally opposing a rear, first and second generally opposing sides, and a top and a bottom. The head 22 may define a striking surface 26 at the front thereof, such as in the form of a poll 28 which defines the striking surface 26, which may be generally planar. Furthermore, the poll 28 may be configured to engage and drive a nail into a structure, and be connected to the remainder of the head 22 by a neck 30.

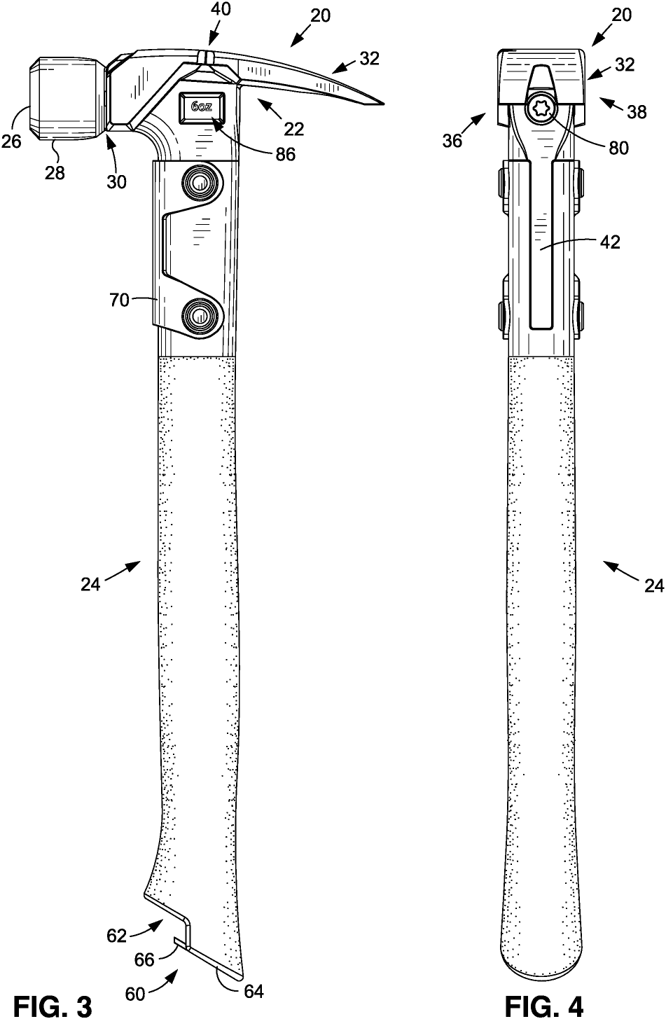

The head 22 may define a claw 32 at the rear thereof. The claw 32 may define a tapered channel 34. The top of the claw 32 may be generally smooth and be slightly arcuate in shape, as better illustrated in FIG. 3. In other configurations, the rear of the head 22 might define another feature instead of a claw.

The first and second sides of the head 22 may comprise a first cheek 36 and a second cheek 38, as illustrated in FIG. 4. As illustrated, one or both cheeks 36, 38 may be inset from a top portion of the head 22. As best illustrated in FIGS. 1 and 2, a nail puller 40 may be defined in the top of the head 22 in order to allow the head 22 to detach nails from structures. The nail puller 40 may comprise, for example, a tapered channel which extends from the side of the head 22 transversely into the head 22. In use, the inset allows a user to locate a head of a fastener at the inset with a shank of the fastener located in the tapered channel. The user can then lever the striking tool 20 to apply an upward force on the head of the fastener.

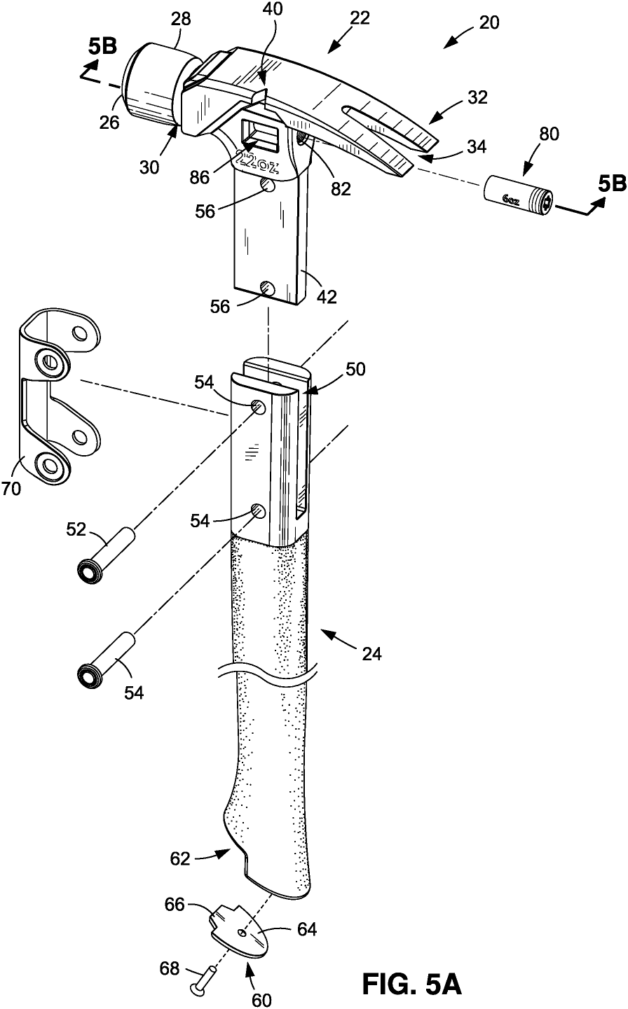

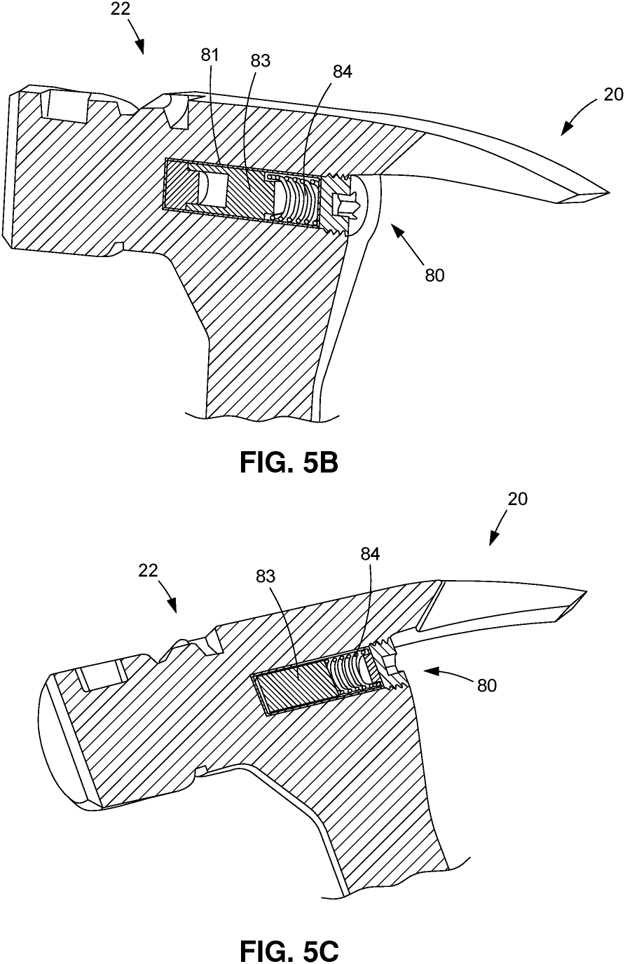

A body 42 extends downwardly from the bottom of the head 22, as shown in FIG. 5A. The body 42 may comprise a neck or similar member. In one embodiment, the head 22 extends from front to rear along a line in the X direction illustrated in FIG. 1, and the body 42 extends downwardly from the head 22 in the Y direction in FIG. 1. In one embodiment, the body 42 is longer (in the X direction in FIG. 1) than it is wide (in the Z direction in FIG. 1).

The handle 24 is connected to the body 42. In one embodiment, the handle 24 is elongate (in the Y direction in FIG. 1), and has a top and a bottom. In one embodiment, the handle 24 may be constructed of wood. However, as indicated herein, the handle 24 might be constructed of metal, fiberglass or other materials.

In one embodiment, the handle 24 has a slot 50 at the top thereof. The slot 50 is sized to receive the body 42 of the head 22 therein. One or more fasteners 52 may be used to connect the handle 24 to the body 42. The fasteners 52 may comprise pins, bolts, screws or other elements/bodies, and may pass through one or more apertures 54 in the handle 24 and aligned apertures 56 in the body 42 (in this example, two aligned sets of apertures are provided, but greater or fewer numbers of apertures might be provided) - where the fasteners 52 extend transversely through the body 42 and handle 24 (e.g. in the Z direction). In another embodiment, the handle may include a body, and the head may include an elongated portion with a slot, into which the body of the handle extends into. Such an embodiment may function equivalent to the embodiment depicted in FIG. 5A.

In one embodiment, a bottle opener 60 (or opening for other containers having caps or similar removable elements) may be defined at the bottom of the handle 24. In one embodiment, the bottom of the handle 24 may define a step 62 having a lower portion and a raised portion. A bottle opener tab 64 may be connected to the raised portion of the step 62 and may include a projection 66 which extends outwardly over the lower portion of the step 62. The opener tab 64 may be connected to the handle 24 in several manners, such as with one or more fasteners 68 such as a screw, as best illustrated in FIG. 5. In use, a user may locate a bottle cap in the step 62 so that an edge thereof is adjacent the projection 66 and may then move the bottle so that the projection 66 engages the cap to dislodge it.

As best illustrated in FIG. 2, the striking tool 20 may include an overstrike protector 70. The overstrike protector 70 may comprise a body, such as sleeve or apron, which covers a front of the handle 24 at the top thereof below the head 22. In the illustrated example, the overstrike protector 70 is generally U-shaped, with a front portion at the front of the handle 24 and side portions which extend long opposing sides of the handle 24. As illustrated, the side portions of the overstrike protector 70 may be mounted to the handle 24, such as via the same fasteners 52 which connect the handle 24 to the body 42 of the head 24. That is, the fasteners 52 may extend through the overstrike protector 70, the top of the handle 24, and the body 42 of the head 22 in order to couple the handle 24 to the head 22, and the overstrike protector 70 to the head 22 and the handle 24. Preferably, the overstrike protector 70 is constructed of a durable material, such as a durable polymer or a metallic material.

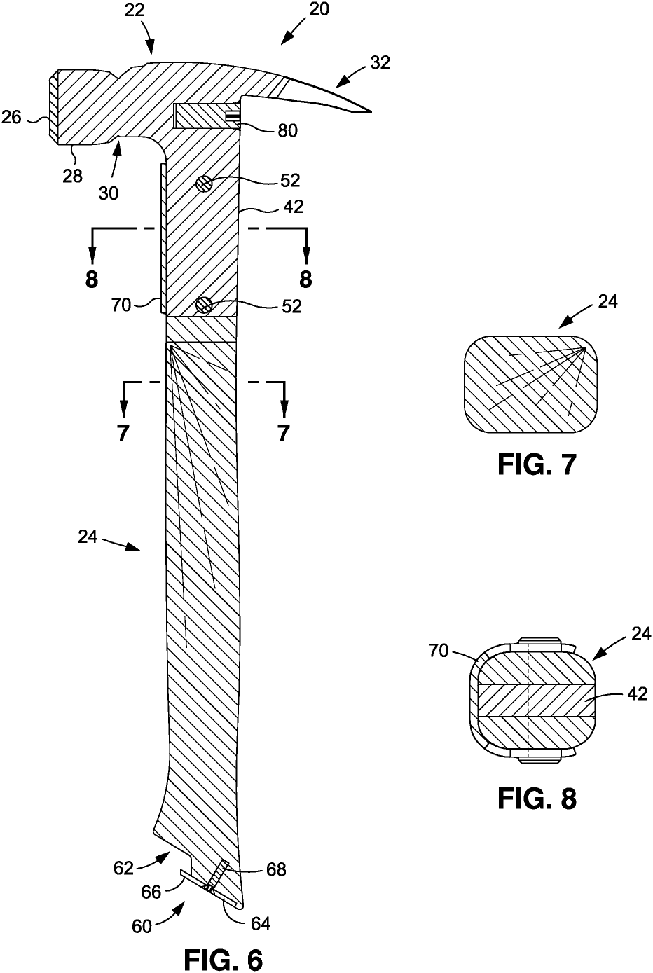

In one embodiment, the striking tool 20 includes an anti-vibration feature. The anti-vibration feature may comprise an anti-vibration insert 80. In one embodiment, the head 22 defines an aperture or opening 82 for receiving the insert 80. In one embodiment, the opening 82 extends into a rear portion of the head 22 towards the front thereof, below the claw 32 (and as illustrated, thus extends in the X direction generally parallel to a line through the front and rear of the head 22). The opening 82 may be cylindrical in shape for accepting a similarly shaped insert 80. It will, however, be appreciated that in suitable alternative embodiments (not shown), the insert may be rectangular-shaped and so may the opening in the head. Furthermore, the insert 80 may be centrally located in the head 22 for maximum vibration absorption. That is, the striking surface 26 of the head 22 may have a center, and the insert 80 may have a longitudinal axis extending through the center, as shown most clearly in FIG. 6. Also shown in FIG. 6, the insert 80 may, in one example, have a length that substantially corresponds to a width of the handle 24, and also be configured to be flush with a rear surface of the head 22. In another example, the insert 80 may be longer, extending deeper into the head 22, without departing from the scope of the disclosed concept.

The insert 80 may be a generally cylindrical body. In one embodiment, the insert 80 may have varying mass, such as by being defined from different materials or by having voids therein. In one embodiment, the insert 80 may be removable from the head 22, such as to be replaced by a different insert 80 having different characteristics, such as a different mass. In one embodiment, at least a portion of the exterior of the insert 80 may be threaded, such as for engaging mating threads defined by the head 22 in the opening. That is, the insert 80 may be threadably coupled to the head 22. One or both ends of the insert 80 may define a tool accepting opening, such as a star, hex or other shaped opening for accepting a mating tool for tightening and loosening the insert 80. It will thus be appreciated that installation and removal of the insert 80 to and from the head 22 is relatively simple, in that all a user needs to do is employ a screwdriver or other tool to turn the insert 80 with respect to the head 22.

In one embodiment, the insert 80 includes a cartridge 81 having a damping feature. As illustrated in FIG. 5B, in one embodiment, the cartridge 81 is threadably coupled to the head 22 and has an open interior space. A body 83 is movably located in the interior space, along with a damping member (e.g., without limitation, biasing member 84). As such, it will be appreciated that the body 83 is movable with respect to the cartridge 81 to allow the biasing member 84 to dampen vibration in the head 22. That is, the body 83 may move, such as in response to the head 22 striking a nail, and be driven into the biasing member 84, which can deform and absorb vibration. Additionally, in one example the body 83 is located between the biasing member 84 and the striking surface 26. Furthermore, as shown in FIG. 5B, the body 83 may extend at least partially into an interior of the biasing member 84 to ensure the biasing member 84 remains centrally located in the insert 80. In another example, as shown in FIG. 5C, the body 83 and the biasing member 84 each abut one another such that the body 83 does not extend into the biasing member 84.

Moreover, the biasing member 84 may comprise, for example, a coil spring (or other element, such as a compressible body, etc.), and be located between a wall or end of the cartridge 81 and the body 83, such as a seat thereof. The biasing member 84 is preferably located towards the rear of the cartridge 81, corresponding to the rear of the head 22, when the cartridge 81 is inserted into the head 22. In use, a force applied to the striking face 26 is transferred through the head 22 to the body 83 which causes the body 83 to move towards the rear of the head 22. The biasing member 84 opposes that motion, absorbing and dissipating that force, reducing the transmission of force through the head 22 to the handle 24. In turn, less vibration will travel from the head 22 to the handle 24, making the operating the striking tool 20 more desirable to a user. That is, the user’s elbow and hand will generally be less taxed when using the striking tool 20, as compared to prior art striking tools (not shown).

FIG. 5C illustrates another embodiment of the insert 80, wherein a size of the body 83 is greater than that illustrated in FIG. 5B. For example, the body 83 of the insert 80 of FIG. 5B has a cavity located therein in order to reduce the mass of the body 83, whereas the body 83 of the insert 80 of FIG. 5C is generally devoid of a cavity. As indicated herein, the mass of the body 83 might change, as might the biasing force generated by the biasing member 84, as part of customizing the damping of the insert 80. In some embodiments, inserts 80 may be pre-configured and sold as individual elements or in sets. In other embodiments, inserts 80 might be sold as modifiable cartridges comprising a housing with an openable end and replaceable bodies/biasing members.

In one embodiment, at least one cheek 36 may define a window 86 that extends into the insert opening 82. The window 86 may have various shapes. In one embodiment, the exterior of the insert 80 may be marked, such as with a mass of the insert (e.g. 6oz, 4oz, 8oz, etc.), where such a marking may align with the window 84 when the insert 80 is fully inserted into the head 22, thus allowing a user to identify the insert 80 and its mass without removing the insert 80. A window 86 might be provided on just one side or both sides of the tool 20.

As indicated, a user might remove one insert 80 and replace it with a different insert 80, such as with one having different characteristics. For example, one user might utilize the striking tool 20 with an insert 80 having a first mass and another user might utilize the striking tool 20 with an insert 80 having a second mass. Changes in the insert 80 (including the mass thereof) may be used to adjust the total mass of the head 22 (swing weight) and/or the anti-vibration characteristics of the striking tool 20.

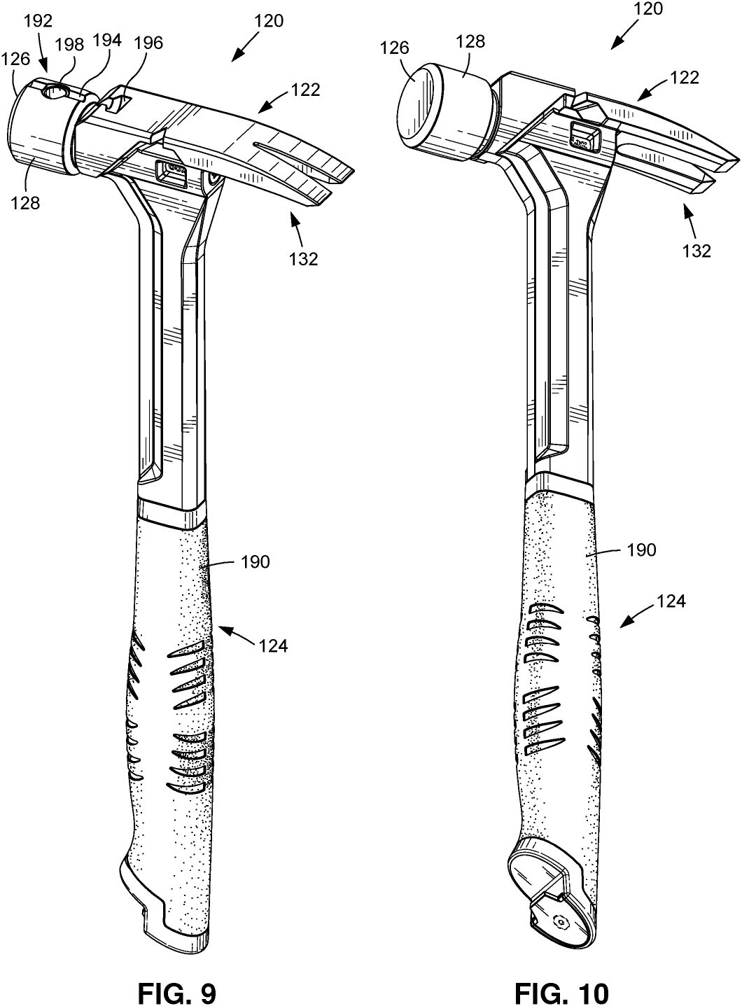

As indicated, the configuration of the striking tool of the invention may vary. For example, FIGS. 9 and 10 illustrate a striking tool 120 of the invention having a head 122 and a metal handle 124, where the head 122 and the handle 124 may be integral (such as be being cast as a single body). This embodiment striking tool 120 may otherwise have many of the same features or characteristics as the striking tool 20 described above, including an anti-vibration feature.

In this embodiment, at least a portion of the handle 124 might include a grip 190. The grip 190 might comprise, for example, a material or body which is placed over a portion of the handle. For example, the grip 190 might comprise a rubber or rubberized material or sleeve which is located over the handle 124.

This embodiment striking tool 124 also includes a magnetic nail starter 192. As illustrated, this feature might comprise a slot 194 which is in the head 122, such as extending from the striking surface 26 along the poll 128 and into the main portion of the head 122, at the top thereof, for accepting a nail. As illustrated, the slot 194 is preferably shaped for securely engaging or accepting a nail or other fastener, defining an enlarged portion 196 for accepting a head of the nail. In one embodiment, at least one magnet 198 may be associated with the head 122, such as the poll 128 for attracting the fastener and maintaining it in the slot 194. In use, a user may insert a fastener into the slot 194, whereby the fastener is held in place by the magnet. The user may then drive the fastener into an object. Once the fastener is set, the user may then disassociate the fastener from the tool 20 and may then strike it with the striking surface 126 of the head 122 one or more times.

Although not illustrated, the first embodiment striking tool 20 described above might also be provided with such a feature.

Additionally, it will be appreciated that a method of operating the striking tool 20, 120 may include the steps of providing the striking tool 20, 120 with a head 22, 122, a handle 24, 124 coupled to or extending from the head 22, 122, and a first insert 80; removing the first insert 80 from the head 22, 122, and providing the striking tool 20, 120 with a second insert, wherein a mass of the second insert is different than a mass of the first insert 80. Additionally, providing the striking tool 20, 120 with the second insert may include threadably coupling the cartridge of the second insert to the head 22, 122.

It will be understood that the above-described arrangements of apparatus and the method there from are merely illustrative of applications of the principles of this invention and many other embodiments and modifications may be made without departing from the spirit and scope of the invention as defined in the claims.

What is claimed is:

1. A striking tool comprising:
a head, said head defining a striking surface and having an opening therein;
a handle coupled to or extending from said head; and
an insert removably insertable into the opening of said head, said insert comprising:
a cartridge having an interior space,
a damping member disposed in the interior space,
a body disposed in the interior space, said body being movable with respect to said cartridge in order to allow said damping member to dampen vibration in said head.

2. The striking tool according to claim 1, wherein said cartridge is threadably coupled to said head.

3. The striking tool according to claim 1, wherein said head comprises a first side and a second side opposite the first side, wherein at least one of the first side and the second side comprises a cheek having window, wherein the window extends into the opening of said head, and wherein said insert is visible through the window.

4. The striking tool according to claim 1, wherein said handle has a slot at a top thereof, wherein said head comprises a body disposed in the slot, wherein said striking tool further comprises an overstrike protector and a number of fasteners, and wherein said number of fasteners extend through said overstrike protector, said top of said handle, and said body of said head in order to couple said handle to said head, and said overstrike protector to said head and said handle.

5. The striking tool according to claim 1, further comprising a bottle opener tab having a projection, wherein said handle has a bottom, wherein said bottom defines a step having a lower portion and a raised portion, wherein said bottle opener tab is connected to said raised portion, and wherein said projection extends outwardly over the lower portion of the step.

6. The striking tool according to claim 1, wherein said head comprises a top having a tapered channel extending from a side of said head transversely into said head in order to allow said head to detach nails from structures.

7. The striking tool according to claim 1, wherein said head further has a slot extending from the striking surface into a main portion of said head, wherein the slot is disposed at a top of said head and is configured for accepting a fastener, and wherein said striking tool further comprises at least one magnet coupled to said head in order to allow the fastener to be maintained in the slot.

8. The striking tool according to claim 1, wherein striking surface has a center, and wherein said insert has a longitudinal axis extending through the center.

9. The striking tool according to claim 1, wherein said damping member is a biasing member.

10. The striking tool according to claim 9, wherein said body of said insert has a cavity disposed therein in order to reduce the mass of said body of said insert.

11. A method of operating a striking tool comprising:
providing said striking tool with a head, a handle coupled to or extending from said head, and a first insert having a first mass, said head defining a striking surface and having an opening therein, said first insert comprising a first cartridge having a first interior space, a first damping member disposed in the first interior space, and a first body disposed in the first interior space, said first body being movable with respect to said first cartridge in order to allow said first damping member to dampen vibration in said head;
removing said first insert from said head; and
providing said striking tool with a second insert removably insertable into the opening of said head, said second insert having a second mass and comprising a second cartridge having a second interior space, a second damping member disposed in the second interior space, and a second body disposed in the second interior space, said second body being movable with respect to said second cartridge in order to allow said second damping member to dampen vibration in said head, wherein the second mass is different than the first mass.

12. The method according to claim 11, wherein providing said striking tool with the second insert comprises threadably coupling said second cartridge to said head.

13. The method according to claim 12, wherein said head comprises a first side and a second side opposite the first side, wherein at least one of the first side and the second side comprises a cheek having window, wherein the window extends into the opening of said head, and wherein providing said striking tool with the second insert comprises disposing said second insert such that said second insert is visible through the window.

14. The method according to claim 11, wherein said handle has a slot at a top thereof, wherein said head comprises a body disposed in the slot, wherein said striking tool further comprises an overstrike protector and a number of fasteners, and wherein said number of fasteners extend through said overstrike protector, said top of said handle, and said body of said head in order to couple said handle to said head, and said overstrike protector to said head and said handle.

15. The method according to claim 11, further comprising a bottle opener tab having a projection, wherein said handle has a bottom, wherein said bottom defines a step having a lower portion and a raised portion, wherein said bottle opener tab is connected to said raised portion, and wherein said projection extends outwardly over the lower portion of the step.

16. The method according to claim 11, wherein said head comprises a top having a tapered channel extending from a side of said head transversely into said head in order to allow said head to detach nails from structures.

17. The method according to claim 11, wherein said head further has a slot extending from the striking surface into a main portion of said head, wherein the slot is disposed at a top of said head and is configured for accepting a fastener, and wherein said striking tool further comprises at least one magnet coupled to said head in order to allow the fastener to be maintained in the slot.

18. The method according to claim 11, wherein said striking surface has a center, and wherein said second insert has a longitudinal axis extending through the center.

19. The method according to claim 11, wherein said second damping member is a biasing member.

20. The method according to claim 19, wherein said biasing member is a coil spring.
